(19) United States
(12) Patent Application Publication
(10) Pub. No.: US 2026/0220287 A1
(43) Pub. Date: Jul. 30, 2026

(54) ACCESS PERMISSIONS FOR RELATED PAGES IN A SYSTEM OF DATABASES

(71) Applicant: Notion Labs, Inc., San Francisco, CA (US)

(72) Inventors: Sophie Chan Alpert, San Francisco, CA (US); Garrett Fidalgo, San Francisco, CA (US)

(21) Appl. No.: 19/038,419

(22) Filed: Jan. 27, 2025

(51) Int. Cl. G06F 21/62; G06F 16/28

(52) U.S. Cl. CPC G06F 21/6218; G06F 16/282

(57) ABSTRACT

The present disclosure provides systems and methods for the management of access permissions for a page of information via inheriting access permissions from a related page. A user may determine a parent page from which a first page inherits access permissions and assign a first page within a database different access permissions than those inherited by other pages in the database. For example, a page may be assigned to a node within a directed acyclic graph and inherit access permissions from one or more parent pages assigned to parent nodes of that node. A page may also be included in a database configured by a user, wherein the database is included in a hierarchy of databases, with child databases inheriting default access permissions from parent databases.

### BACKGROUND

Access control and permission management are critical aspects of modern collaborative software platforms. Access control and permission management determine who may access certain data, apps, and/or other resources, allowing access to be restricted such that unauthorized users are unable to view or modify sensitive information. Controlling access to a certain resource may involve assigning users, groups, or devices different permissions to access resources based on predefined rules. These rules may be based on a wide range of factors, including the role of the user, how sensitive the resource is, and the type of resource, among others. Organizations increasingly rely on digital tools for communication, project management, and information sharing, with each of these tools offering varying degrees of granularity for access control.

### BRIEF DESCRIPTION OF THE DRAWINGS

Reference will now be made, by way of example, to the accompanying drawings, which show example embodiments of the present application and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is a block diagram illustrating a number of related pages organized in a directed acyclic graph structure.

FIG. 5 is a block diagram illustrating a hierarchy of databases.

FIGS. 6A and 6B are illustrations of an example permissions interface.

FIG. 7 is an illustration of an example database list view.

FIG. 8 is a flow diagram illustrating an example method of updating access permissions for pages.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for the management of access permissions for a page of information via inheriting access permissions from a related page. Traditional hierarchical access control models often struggle to accommodate the complex relationships between different types of content and users within an organization. For example, present technologies involving relationships between pages typically do not allow a user to structure access permissions in a way other than a purely hierarchical tree in which each child page inherits access permissions from only one parent page and each page within a database shares access permissions with other pages in the database. Furthermore, present technologies that categorize pages into databases do not allow for the creation of new databases or new relationships to be created between existing databases to facilitate the inheritance of access permissions. These technologies limit the flexibility of users in assigning access permissions to different objects, making it difficult to ensure that a given user has access to an appropriate set of pages.

The systems and methods disclosed herein overcome this limitation by allowing a user to determine a parent page from which a first page inherits access permissions and to assign the first page within a database different access permissions than those inherited by other pages in the database. In some embodiments, the page is assigned to a node within a directed acyclic graph and inherits access permissions from one or more parent pages assigned to parent nodes of that node, allowing access permissions to be inherited from multiple pages. In other embodiments, each page is included in a database configured by a user and databases are organized into a hierarchy, with child databases inheriting default access permissions from parent databases. Because each database is configured by the user, new databases can be created and relationships between existing databases can be modified, enabling the user to establish a system of access permission inheritance desirable for the user's objectives regardless of the existing relationships between databases and pages.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested subpages inside of pages). The content attribute of a block stores the array of block IDs (or pointers) referencing those nested blocks. Each block defines the position and order in which its content blocks are rendered. This hierarchical relationship between blocks and their render children is referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer” the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title and checked: [[“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory, and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then, the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

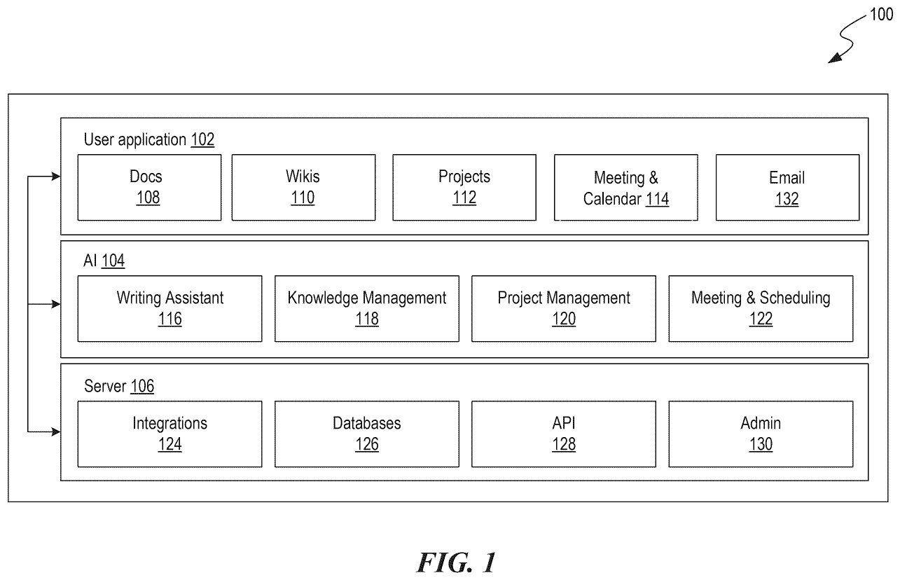

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or subpages). Blocks can be assigned to certain properties. The blocks can be defined by boundaries having dimensions. The boundaries can be visible or non-visible for users. For example, a block can be assigned as a text block (e.g., a block including text content), a heading block (e.g., a block including a heading), or a subheading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as AI-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100, can include an embedding of a document within the platform 100, or an embedding of a block in the document. In another example, a wiki can link to a meeting within the calendar.

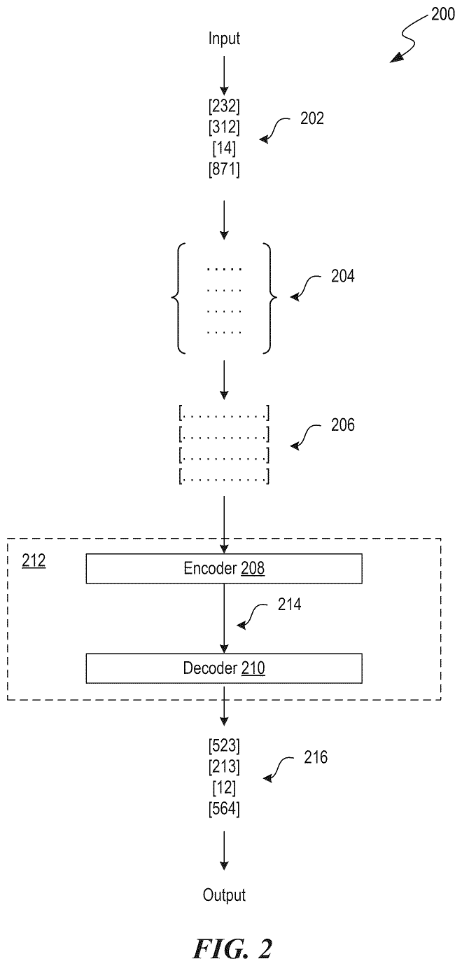

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto-filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”), and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks, and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder) or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger dataset and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture) unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on input formats other than natural language input. For example, the input can include objects, images, audio content, video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture) unless stated otherwise. Some LLMs can be trained on a large multi-language, multi-domain corpus to enable the model to be versatile at a variety of language-based tasks, such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts, such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question, “What is the weather like in San Francisco?” and the output can include a description of the weather in San Francisco. As another example, the input can include a request to brainstorm names for a flower shop, and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

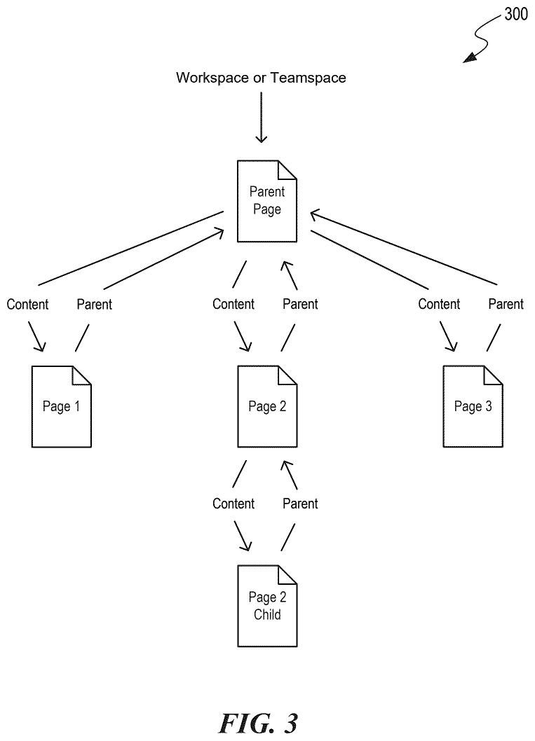

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include one or more blocks such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children, while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet, while “Page 2” is only shared internally with the users associated with the workspace. As another example, “Page 2 Child” can be shared only with an individual user, while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Relationships Between Pages and Databases

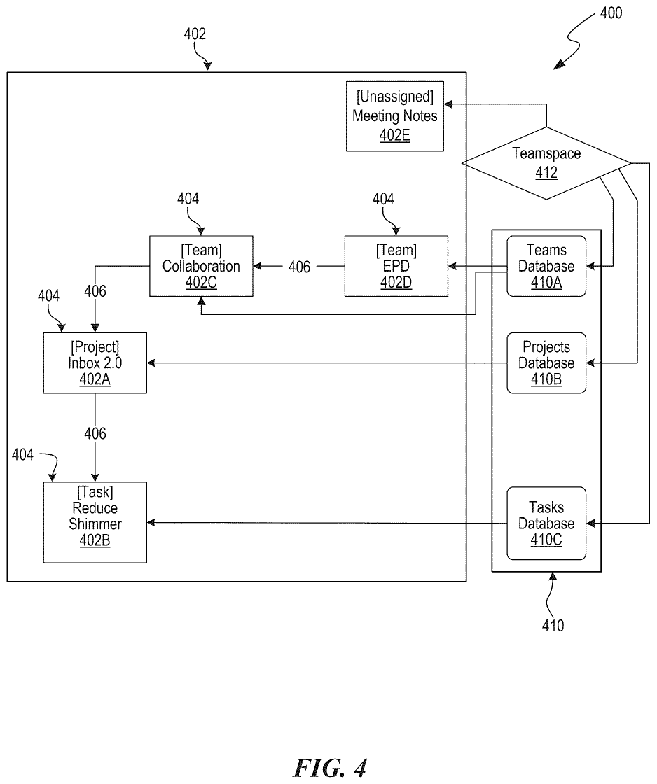

FIG. 4 is a block diagram illustrating a number of related pages organized in a directed acyclic graph structure 400. Shown are a number of pages 402, with each page 402 being assigned to a node 404 of a graph. A graph is a data structure consisting of nodes 404 and connections 406 between nodes 404, which represent relationships between connected nodes 404. In some embodiments, such as the one depicted in FIG. 4, the graph has a directed acyclic structure, meaning the connections 406 have a direction (denoted by arrows) indicating which node 404 of a pair of connected nodes is a child node. For example, when a connection 406 leads from a first node to a second node, the first node is a parent node of the second node, and when a connection 406 leads from the second node to the first node, the first node is a child node of the second node. Furthermore, connections 406 in the directed acyclic structure are directed such that following the direction of connections 406 leading out from a node 404 does not lead back to the node 404. For example, following the direction of connections 406 leading out from the node 404 to which the “Collaboration” page 402C is assigned leads to the nodes 404 containing the “Inbox 2.0” page 402A and the “Reduce Shimmer” page 402B but does not lead back to the node 404 containing the “Collaboration” page 402C itself. Thus, a node 404 may be a relative of many other nodes 404 but not a relative of itself.

In some embodiments, a parent page is associated with each page 402 from which the page 402 inherits access permissions. For example, the parent page may be assigned to a parent node of the node 404 to which the page 402 is assigned. Continuing with the same example, access permissions are inherited in the same direction as the connection 406 between nodes 404, such that a page 402 in a child node inherits access permissions from a parent page in a parent node of the child node. In some embodiments, the inherited access permissions may indicate that a user with access to the parent page also has access to the page 402. Inheriting the access permissions and/or modifying the access permissions of a parent page may result in a matching modification of the access permissions of the page 402, which inherited access permissions from the parent page. Furthermore, in some embodiments, pages 402 may have more than one parent page from which they inherit access permissions, such as when a page 402 is assigned to a node 404 in a directed acyclic graph that has multiple parent nodes. In these and other embodiments, a new page 402 may be generated at the direction of a user and assigned to a node 404, inheriting access permissions in the manner described above.

In some embodiments, a page 402 may be included in a database 410 configured to contain pages 402 and/or other databases 410 and data objects. As depicted in FIG. 4, there are three different databases 410: the “Teams” database 410A, “Projects” database 410B, and “Tasks” database 410C, and the arrow(s) pointing from each database 410 to a node 404 indicate that the database 410 contains the page 402 assigned to the node 404. For example, the “Teams” database 410A contains both the “Collaboration” and “EPD” pages 402C, 402D, while the “Projects” database 410B contains only the “Inbox 2.0” page 402A. In some embodiments, each database 410 is configured by a user to have a set of properties that are attributed to pages 402 within the database 410 and may be defined and/or modified by a user. For example, a database 410 may have associated access permissions that serve as the default access permissions applied to pages 402 within that database 410. Other examples of properties may include a name, a status indicating the type of page 402, a description, an associated page 402, or an associated user. Therefore, pages 402 within databases 410 will inherit the access permissions associated with the database 410 unless access permissions for an individual page 402 are modified to differ from the default. In these and other embodiments, a new page 402 may be generated by a user and included in a database 410 at the time of generation, thereby inheriting access permissions without the need for further configuration by the user.

In some embodiments, when a page 402 is added to a database 410 and/or when the access permissions associated with the database 410 containing a page 402 are modified, the access permissions associated with the page 402 are modified to match those of the database 410. Additionally or alternatively, modifying the access permissions associated with a database 410 (e.g., by picking a property of the database 410 to act as the property determining access to the database 410) may simultaneously update the access permissions associated with all pages 402 in that database to match. However, in these and other embodiments, a user may be able to override the access permissions associated with a page 402 by inputting new access permissions to be associated with the page 402, which replace the access permissions inherited from the database 410. For example, a user may indicate that a page 402 inherits the access permissions of a parent page of the page 402 instead of or in addition to inheriting access permissions from the database 410 containing the page 402 itself. Continuing with the same example, the parent page may be contained in a different database 410 than the page 402 and inherit certain access permissions from that database 410, which are then applied to the page 402 despite the page 402 not being in that database 410. Additionally or alternatively, access permissions may be assigned based on properties of a page 402 other than the page's 402 relationship to other pages 402 or databases 410, and rules for resolving conflicts between different assignments of access permissions (e.g., one assignment based on an associated page 402 and another assignment based on status) may be configured by a user. As a result of the customizability of access permission described above, pages 402 may have different access permissions from other pages 402 in the same database 410. In some embodiments, only users with specific levels of access (e.g., edit access rather than mere viewing access) to a page 402 or database 410 can modify the access permissions associated with that page 402 or database 410.

In some embodiments, a teamspace 412 is provided that is configured to include a plurality of unassigned objects that may inherit properties and/or access permissions from the teamspace 412. For example, as depicted in FIG. 4, each of the databases 410 is included in the teamspace 412, as indicated by arrows leading out from the teamspace 412, and may inherit a set of default access permissions from the teamspace 412 designating which users that can access those databases 410 by default. In some embodiments, a page 402 not assigned to a database 410 may be assigned to the teamspace 412 and inherit default access permissions from the teamspace 412. Such an embodiment is depicted in FIG. 4 by the arrow leading from the teamspace 412 to the unassigned page 402E entitled “Meeting Notes.”

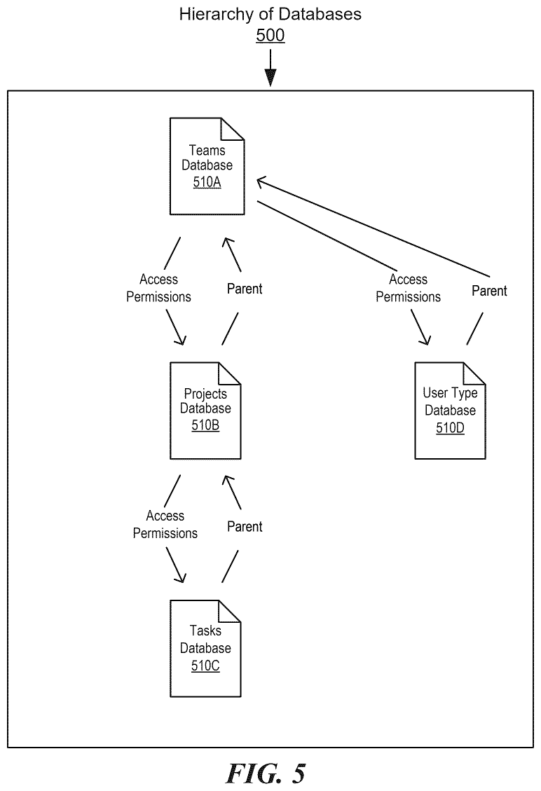

FIG. 5 is a block diagram illustrating a hierarchy of databases 500. In some embodiments where pages are included in a database, the databases may be organized in a hierarchical tree structure in which databases may have a parent-child relationship with one another and no one database has more than one parent database. For example, as shown in FIG. 5, the “Teams” database 510A is a parent database of the “Projects” database 510B, and the “Projects” database 510B is both a child database of the “Teams” database 510A and a parent database of the “Tasks” database 510C.

In some embodiments, each child database inherits access permissions from a parent database such that those access permissions become associated with the child database, as depicted in FIG. 5 by the arrows indicating that each database with a parent receives access permissions from that parent. For example, the “Teams” database 510A may have associated access permissions designating that a certain set of users may access all pages in the “Teams” database 510A by default. In such an example, these access permissions are inherited by the “Projects” database 510B and then the “Tasks” database 510C in turn, allowing the same set of users to access the pages in those databases as well. In some embodiments, pages in a database are constrained by this hierarchy such that each page can only inherit access permissions from a page or database that is located higher in the hierarchy of databases 500.

In some embodiments, a user may create and configure a new database that is added to the hierarchy of databases 500. For example, as depicted in FIG. 5, the “User Type” database 510D is created and configured by the user such that a certain set of properties is attributed to pages within the database, in contrast to the “Teams,” “Projects,” and “Tasks” databases 510A-C, which are not created by the user (they may be created by, e.g., an application developer or third party) and have a set of preconfigured properties that are attributed to their pages. As depicted in FIG. 5, the user has configured the “User Type” database 510D to inherit access permissions from the “Teams” database 510A. The “User Type” database 510D is therefore a child database of the “Teams” database 510A, as is the preconfigured “Projects” database 510B, and therefore inherits the same access permissions as the “Projects” database 510B.

### Example Interfaces

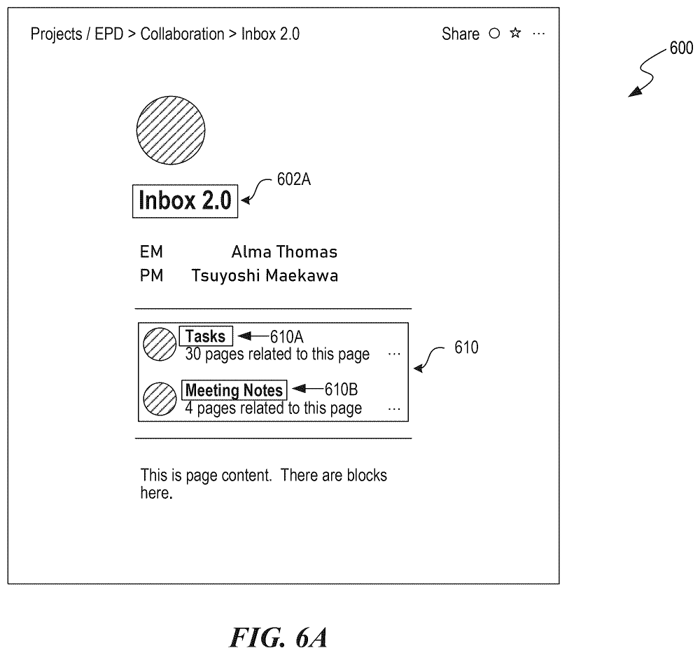

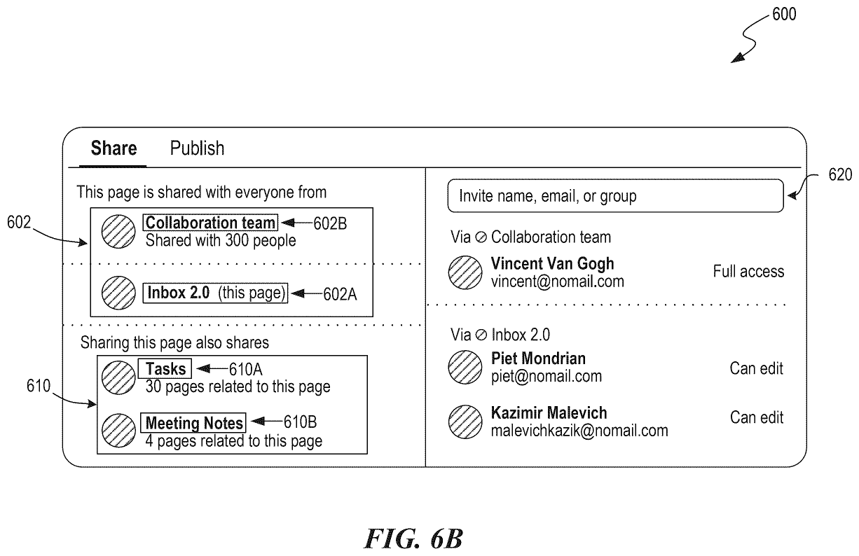

FIGS. 6A and 6B are illustrations of an example permissions interface 600. In some embodiments, the permissions interface contains information about a page 602, including the identity of select users with access to the page 602, whether the page 602 is a parent page or a child page, and/or the identity of pages related to the page 602. For example, as depicted in FIG. 6A, the permissions interface 600 indicates that the “Inbox 2.0” page 602A is managed by users “Alma Thomas” and “Tsuyoshi Maekawa” and is a parent page, as denoted by the listing of the “Tasks” and “Meeting Notes” databases 610A, 610B, which indicates that the databases 610 include pages 602 related to the “Inbox 2.0” page 602A. In other embodiments, identifying information for pages 602 related to a parent page, such as a name for each page, may be listed directly alongside the parent page rather than the name of the database 610 containing those pages.

In some embodiments, a user may view and modify access permissions associated with a page 602 via the permissions interface 600. For example, as depicted in FIG. 6B, the permissions interface 600 indicates that the user “Vincent Van Gogh” has full access to the “Inbox 2.0” page 602A via the “Collaboration team” page 602B. In this example, the “Collaboration team” page 602B is a parent page of the “Inbox 2.0” page 602A and has access permissions configured such that users with access to the “Collaboration team” page 602B also have access to child pages inheriting access permissions from the “Collaboration team” page 602B. Thus, the user “Vincent Van Gogh” automatically gains access to the “Inbox 2.0” page 602A by virtue of the “Inbox 2.0” page 602A being a child page of the “Collaboration team” page 602B. Continuing with the same example, a user may be able to revoke or modify the level of access “Vincent Van Gogh” has to the “Inbox 2.0” page 602A via the permissions interface 600. In these and other embodiments, access permissions may be additionally configured such that modifying the access permissions of a parent page results in a matching modification of the access permissions of at least one child page of the parent page. For example, as depicted in FIG. 6B, modifying the access permissions of the “Collaboration team” page 602B such that “Vincent Van Gogh” no longer has access would also remove that user's access to the “Inbox 2.0” page 602A.

In some embodiments, a user may invite new users to access a page 602 via an invite bar 620 or other feature included in the permissions interface 600. For example, as depicted in FIG. 6B, an invite bar 620 is located above a list of users with access to the “Inbox 2.0” page 602A and allows a user to modify the access permissions of the “Inbox 2.0” page 602A such that additional users and/or groups of users have access.

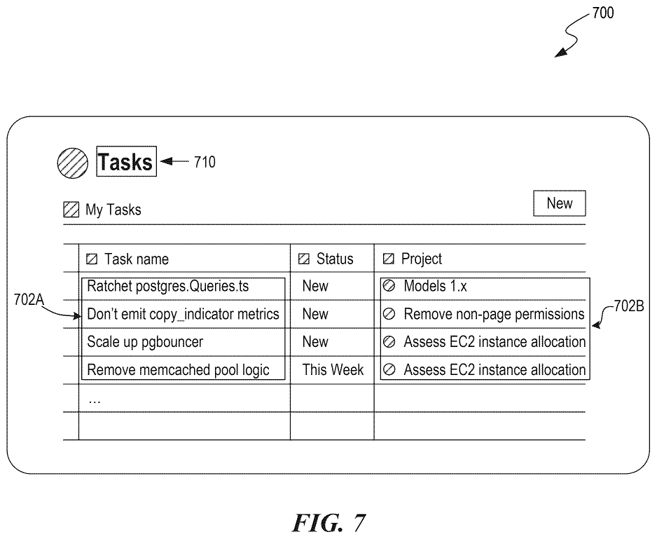

FIG. 7 is an illustration of an example database list view 700. A database list view 700 is an interface available to a user that lists one or more pages 702A to which the user has access, as determined by the access permissions associated with those pages. In some embodiments, the database list view 700 is also configurable such that the pages 702A to which the user has access within a certain database 710 are highlighted. For example, as depicted in FIG. 7, the database list view 700 is highlighting the pages 702A to which the user has access from the “Tasks” database 710. In these and other embodiments, the database list view 700 may indicate a parent page 702B associated with each page 702A to which the user has access. For example, as depicted in FIG. 7, a parent page 702B of each page 702A from the “Tasks” database 710 is listed alongside each page 702A, indicating the relationship between the pages 702A, 702B.

### Example Method of Updating Access Permissions

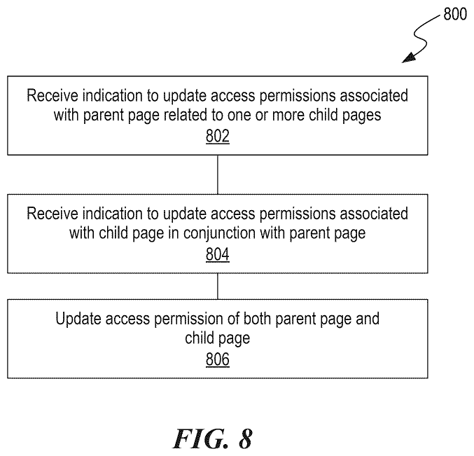

FIG. 8 is a flow diagram illustrating an example method 800 of updating access permissions for pages. In step 802, an indication to update access permissions associated with a parent page related to one or more child pages is received. In some embodiments, the parent page is related to the one or more child pages in a graph of pages having a directed acyclic structure, as described in relation to FIG. 4, and/or in another form of relational hierarchy. In step 804, an indication that the access permissions associated with a child page from the one or more child pages are to be updated in conjunction with the parent page is received. For example, this indication may be a configuration by a user of the access permissions of the child page and/or parent page such that modifying the access permissions of the parent page results in a matching modification of the child page. In step 806, the access permissions of both the parent page and child page are updated. For example, this update may include adding, removing, or modifying the level of access of a user or a group of users to both the parent and child page.

### Computer System

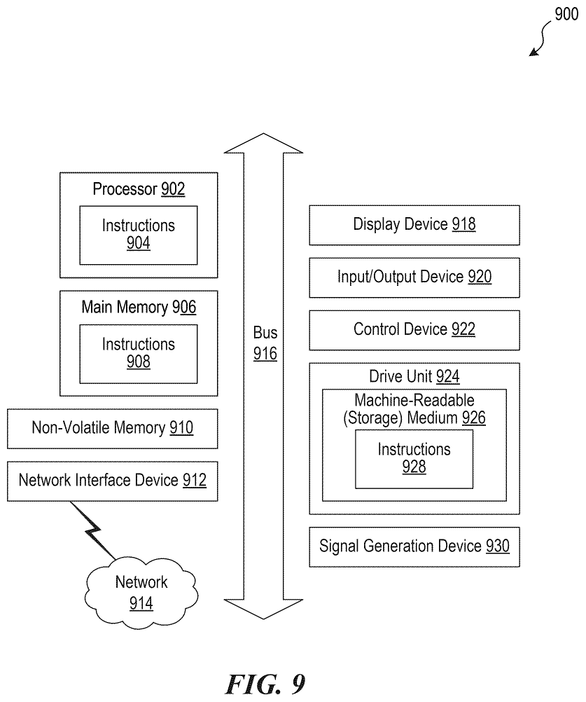

FIG. 9 is a block diagram that illustrates an example of a computer system 900 in which at least some operations described herein can be implemented. As shown, the computer system 900 can include one or more processors 902, main memory 906, non-volatile memory 910, a network interface device 912, a display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variant thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions recorded thereon, wherein the instructions, when executed by at least one data processor of a system, cause the system to:
receive an indication of a first page from a user,
wherein the first page is included in a first database containing a plurality of pages that inherit properties from the first database, and
wherein the first database is configured by the user;
assign the first page to a node within a graph of pages having a directed acyclic structure,
wherein the graph includes a plurality of nodes,
wherein connections between nodes in the graph have a direction such that following the direction of connections leading out from a node does not lead back to the node,
wherein a first node is a parent node of a second node when a connection leads from the first node to the second node, and
wherein the first node is a child node of the second node when a connection leads from the second node to the first node;
associate a parent page with the first page and a second page from which the first and second pages inherit access permissions,
wherein the parent page is included in a second database configured by the user that differs from the first database,
wherein the parent page is assigned to a parent node of the node to which the first and second pages are assigned,
wherein the access permissions indicate that a user with access to the parent page also has access to pages that inherit the access permissions from the parent page, and
wherein the access permissions indicate that modifying the access permissions of the parent page results in a matching modification of the access permissions of the pages that inherit the access permissions from the parent page;
associate the access permissions inherited from the parent page with the first page and the second page;
receive an input from the user of new access permissions to be associated with the first page; and
replace the access permissions associated with the first page with the new access permissions,
thereby allowing the first page to have different access permissions from the second page despite sharing a parent page with the second page.

2. The non-transitory, computer-readable storage medium of claim 1, further comprising instructions to:
generate a new page,
wherein the new page is included in a third database configured by the user;
obtain a hierarchy of databases including the first database, the second database, and the third database,
wherein the hierarchy of databases has a tree structure such that a database above another database in the hierarchy of databases is a parent database and the database below the parent database is a child database, and
wherein each database has no more than one parent database;
upon receiving an indication from the user that either the first database or the second database is the child database of the third database, associate access permissions inherited from the third database with the child database; and
upon receiving an indication from the user that either the first database or the second database is the parent database of the third database, associate access permissions inherited from the parent database with the third database.

3. The non-transitory, computer-readable storage medium of claim 1, further comprising instructions to:
cause display of a permissions interface,
wherein the permissions interface contains information about the parent page including an identity of at least one of the first page or the second page, and
wherein the user modifies the access permissions associated with the parent page via the permissions interface;
receive an indication that the user has modified the access permissions associated with the parent page; and
modify the access permissions associated with the first and second pages to match the access permissions associated with the parent page.

4. The non-transitory, computer-readable storage medium of claim 1, further comprising instructions to:
cause display of a database list view,
wherein each page with associated access permissions allowing the user to access the page is listed, and
wherein a parent page and a database associated with each listed page are indicated.

5. A system comprising:
at least one hardware processor; and
at least one non-transitory memory storing instructions, which, when executed by the at least one hardware processor, cause the system to:
receive an indication of a first page from a user;
associate a parent page with the first page and a second page from which the first and second pages inherit access permissions;
associate the access permissions inherited from the parent page with the first page and the second page;
receive an input from the user of new access permissions to be associated with the first page; and
replace the access permissions associated with the first page with the new access permissions,
thereby allowing the first page to have different access permissions from the second page despite sharing a parent page with the second page.

6. The system of claim 5, further comprising instructions causing the system to:
include the first page in a first database configured by the user;
include the parent page in a second database configured by the user;
obtain a hierarchy of databases including the first database and the second database,
wherein the hierarchy of databases has a tree structure such that a database above another database in the hierarchy of databases is a parent database and the database below the parent database is a child database,
wherein each database has no more than one parent database, and
wherein the second database is the parent database of the first database; and
associate access permissions associated with the second database with the first database.

7. The system of claim 5, further comprising instructions causing the system to:
include the first page in a first database configured by the user;
generate a new page,
wherein the new page is included in a second database configured by the user;
obtain a hierarchy of databases including the first database and the second database,
wherein the hierarchy of databases has a tree structure such that a database above another database in the hierarchy of databases is a parent database and the database below the parent database is a child database, and
wherein each database has no more than one parent database;
upon receiving an indication from the user that the first database is the child database of the second database, associate access permissions inherited from the second database with the first database; and
upon receiving an indication from the user that the first database is the parent database of the second database, associate access permissions inherited from the first database with the second database.

8. The system of claim 5, further comprising instructions causing the system to:
assign the first page to a node within a graph of pages having a directed acyclic structure,
wherein the graph includes a plurality of nodes,
wherein connections between nodes in the graph have a direction such that following the direction of connections leading out from a node does not lead back to the node,
wherein a first node is a parent node of a second node when a connection leads from the first node to the second node, and
wherein the first node is a child node of the second node when a connection leads from the second node to the first node; and
associate with the first page a parent page from which the first page inherits access permissions,
wherein the parent page is assigned to the parent node of the node to which the first page is assigned.

9. The system of claim 8, further comprising instructions causing the system to:
generate a new page at the direction of a user;
assign the new page to a node within the graph of pages that is a child node of at least one parent node; and
associate with the new page a parent page from which the new page inherits access permissions,
wherein the parent page is assigned to one of the at least one parent nodes.

10. The system of claim 5, further comprising instructions causing the system to:
configure the access permissions such that a user with access to the parent page also has access to pages that inherit the access permissions from the parent page; and
configure the access permissions such that modifying the access permissions of the parent page results in a matching modification of the access permissions of the pages that inherit the access permissions from the parent page.

11. The system of claim 5, further comprising instructions causing the system to:
cause display of a permissions interface,
wherein the permissions interface contains information about the parent page including an identity of at least one of the first page or the second page, and
wherein the user modifies the access permissions associated with the parent page via the permissions interface;
receive an indication that the user has modified the access permissions associated with the parent page; and
modify the access permissions associated with the first and second pages to match the access permissions associated with the parent page.

12. The system of claim 5, further comprising instructions causing the system to:
cause display of a database list view,
wherein each page with associated access permissions allowing the user to access the page is listed, and
wherein a parent page and a database associated with each listed page are indicated.

13. The system of claim 5, further comprising instructions causing the system to:
provide a teamspace configured to include a plurality of unassigned objects,
wherein the plurality of unassigned objects includes at least one of a page not contained within a database or a database;
associate default access permissions with the teamspace;
include an unassigned object that does not already have associated access permissions in the teamspace; and
associate the default access permissions with the unassigned object.

14. A method comprising:
receiving an indication to update access permissions associated with a parent page,
wherein the parent page is related to one or more child pages in a graph of pages having a directed acyclic structure,
wherein the graph includes a plurality of nodes,
wherein connections between nodes in the graph have a direction such that following the direction of connections leading out from a node does not lead back to the node,
wherein a first node is a parent node of a second node when a connection leads from the first node to the second node, and
wherein the first node is a child node of the second node when a connection leads from the second node to the first node;
receiving an indication that access permissions associated with a child page from the one or more child pages are to be updated in conjunction with the parent page; and
updating the access permissions of both the parent page and the child page.

15. The method of claim 14, further comprising:
including a child page from the one or more child pages in a first database configured by a user;
including the parent page in a second database configured by the user;
obtaining a hierarchy of databases including the first database and the second database,
wherein the hierarchy of databases has a tree structure such that a database above another database in the hierarchy of databases is a parent database and the database below the parent database is a child database,
wherein each database has no more than one parent database, and
wherein the second database is the parent database of the first database; and
associating access permissions associated with the second database with the first database.

16. The method of claim 14, further comprising:
including a child page from the one or more child pages in a first database configured by a user;
generating a new page,
wherein the new page is included in a second database configured by the user; and
obtaining a hierarchy of databases including the first database and the second database,
wherein the hierarchy of databases has a tree structure such that a database above another database in the hierarchy of databases is a parent database and the database below the parent database is a child database, and
wherein each database has no more than one parent database.

17. The method of claim 16, further comprising:
upon receiving an indication from the user that the first database is the child database of the second database, associating access permissions inherited from the second database with the first database.

18. The method of claim 16, further comprising:
upon receiving an indication from the user that the first database is the parent database of the second database, associating access permissions inherited from the first database with the second database.

19. The method of claim 14, further comprising:
configuring the access permissions such that a user with access to the parent page also has access to the one or more child pages; and
configuring the access permissions such that modifying the access permissions of the parent page results in a matching modification of the access permissions of the one or more child pages.

20. The method of claim 14, further comprising:
providing a teamspace configured to contain a plurality of unassigned objects,
wherein the plurality of unassigned objects includes at least one of a page not contained within a database or a database;
associating default access permissions with the teamspace;
including an unassigned object that does not already have associated access permissions in the teamspace; and
associating the default access permissions with the unassigned object.
